(19) United States
(12) Patent Application Publication
(10) Pub. No.: US 2005/0074672 A1
(43) Pub. Date: Apr. 7, 2005

(54) Negative active material for rechargeable lithium battery, method of preparing same and rechargeable lithium battery using same

(76) Inventors: Keiko Matsubara, Yokohama-shi (JP); Sung-Soo Kim, Suwon-si (KR); Bok-Hwan Jung, Suwon-si (KR)

Correspondence Address: CHRISTIE, PARKER & HALE, LLP, PO BOX 7068, PASADENA, CA, 91109-7068, US

(21) Appl. No.: 10/957,197

(22) Filed: Oct. 1, 2004

(30) Foreign Application Priority Data
Oct. 1, 2003 (JP) 2003-343611
Feb. 12, 2004 (KR) 2004-0009365

(51) Int. Cl. H01M 4/40; H01M 4/04; B05D 5/12; H01M 4/62

(52) U.S. Cl. 429/231.95; 429/232; 427/113; 427/123

(57) ABSTRACT

Disclosed is a negative active material for a rechargeable lithium battery including a composite of a graphite particle and at least one supermicroparticle, wherein the supermicroparticle has a diameter in the range of 1 nm to 100 nm, is produced using an evaporation method under a gas atmosphere, and includes elements alloyable with lithium.

### CROSS REFERENCE TO RELATED APPLICATION

This application claims priority to, and is based on Japanese Patent Application No. 2003-343611 filed in the Japan Patent Office on Oct. 1, 2003, and Korean Patent Application No. 10-2004-009365 filed in the Korean Intellectual Property Office on Feb. 12, 2004, the entire disclosures of which are incorporated hereinto by reference.

### FIELD OF THE INVENTION

The present invention relates to a negative active material for a rechargeable lithium battery, a method of manufacturing the same, and a rechargeable lithium battery using the same.

### BACKGROUND OF THE INVENTION

Materials such as Si-based alloys, Sn-based alloys, metal lithium, and metal oxides have been under study as alternative materials to graphite as a negative active material for a rechargeable lithium battery. These materials, compared to graphite, have high charge-discharge capacity per weight but reveal problems such as their tendency to form dendrites and pulverize due to the expansion-contraction which occurs upon charge-discharge cycling, and their low coulombic efficiency. Except for lithium metal, these materials also tend to have low energy density due to low battery voltage.

Consequently, graphite-metal composite materials have been proposed in an attempt to solve such problems. For example, Japanese Patent Laid-Open No. Hei. 9-249407 sets forth one attempt. Such composite materials have the high capacity characteristics of metal particles and excellent cycle characteristics due to the graphite particles. Therefore, such composite materials look promising for next-generation negative active materials.

Si is in wide use as a particle for a composite material due to its relatively high capacity per weight. However, because Si tends to experience a large volume change upon charge-discharge cycling, Si and graphite particles tend to detach from each other over repeated charge-discharge, resulting in the destruction of the composite material itself. Thus, Si supermicroparticles having an average diameter of hundreds of nanometers have been used as Si particles and the means for preventing the destruction of a composite material by decreasing the absolute volume change of Si particles has been intensively studied.

### SUMMARY OF THE INVENTION

According to one embodiment of the present invention a negative active material for a rechargeable lithium battery is provided which exhibits less volume change upon charge-discharge and has excellent cycle characteristics.

In another embodiment of the invention, a rechargeable lithium battery is provided including the negative active material.

In yet another embodiment of the present invention, a method is provided for preparing the negative active material for the rechargeable lithium battery.

While Si supermicroparticles having an average diameter of hundreds of nanometers are usually obtained by mechanical pulverization and supermicronization of Si, the resulting Si supermicroparticles have broad particle size distributions in the range of several nanometers to several micrometers. Consequently, those Si particles having a large particle size increase the absolute volume change and destroy the composite material itself, thereby resulting in the dramatic deterioration of the cycle characteristics. Therefore, in one embodiment of the present invention a negative active material for a rechargeable lithium battery is provided which includes a composite of a graphite particle and at least one supermicroparticle, the supermicroparticle having a diameter in the range of 1 nm to 100 nm, being an element alloyable with lithium, and being prepared using an evaporation method under a gas atmosphere.

In another embodiment of the present invention a rechargeable lithium battery is provided with a negative electrode including the negative active material, a positive electrode, and an electrolyte.

According to another embodiment of the present invention, a method is provided for preparing a negative active material for a rechargeable lithium battery. In this method, at least one supermicroparticle made of an element alloyable with lithium and having a diameter in the range of 1 nm to 100 nm is prepared using an evaporation method under a gas atmosphere and the supermicroparticle is immobilized onto a surface of a graphite particle mechanically.

### BRIEF DESCRIPTION OF THE DRAWINGS

FIG. 1 is a schematic drawing illustrating one embodiment of a negative active material for a rechargeable lithium battery according to the present invention;

FIG. 2 is a schematic drawing illustrating another embodiment of a negative active material for a rechargeable lithium battery according to the present invention;

FIG. 3A is a SEM photograph at 10,000× magnification of the supermicroparticles used in the negative active material according to Example 1 of the present invention;

FIG. 3B is a SEM photograph at 30,000× magnification of the supermicroparticles used in the negative active material according to Example 1 of the present invention;

FIG. 4 is a graph illustrating the Raman spectrum of the supermicroparticles used in the negative active material according to Example 1 of the present invention;

FIG. 5 is a SEM photograph at 10,000× magnification of the supermicroparticles used in the negative active material according to Example 3 of the present invention;

FIG. 6 is a graph illustrating the Raman spectrum of the supermicroparticles used in the negative active material according to Example 3 of the present invention; and

FIG. 7 is a schematic view showing an embodiment of a lithium secondary battery according to the present invention.

### DETAILED DESCRIPTION

The present invention provides a negative active material for a rechargeable lithium battery. The negative active material includes a composite of a graphite particle and at least one supermicroparticle with a diameter in the range of 1 nm to 100 nm. The supermicroparticle is an element alloyable with lithium, and is prepared by an evaporation method under a gas atmosphere.

The supermicroparticle has a diameter distribution width as narrow as 1 nm to 100 nm, and includes particles having a maximum diameter of 100 nm. Due to the size effect, such a supermicroparticle has a different crystalline structure compared to larger particles, leading to less absolute volume change even when alloyed with lithium. Consequently, even with charge-discharge cycling following the aggregation of at least one supermicroparticle and the graphite particle, separation of the supermicroparticle from the graphite particle does not occur. This improves the cycle life characteristics.

The diameter of each supermicroparticle is preferably in the range of 1 nm to 50 nm. Having each supermicroparticle with a diameter in the range of 1 nm to 50 nm tends to result in superior cycle life characteristics due to a lower volume change upon charge-discharge.

The supermicroparticles are preferably made of Si. Due to the high charge-discharge capacity of Si with respect to lithium, it is possible to provide a negative active material with high capacity.

Additionally, in one embodiment of the invention, a negative active material for a rechargeable lithium battery of the present invention requires that the supermicroparticle includes both of Si and SiM phases and at least one of X and SiX phases, where M is at least one element selected from Ni, Co, B, Cr, Cu, Fe, Mg, Mn, and Y, and X is at least one element selected from Ag, Cu, and Au, provided that M and X are not both Cu.

According to the composition, the supermicroparticle should include an SiM phase that is not alloyable with lithium, thereby preventing the volume change of the supermicroparticle upon charge-discharge cycling, and improving the cycle characteristics.

The supermicroparticle also includes an X phase or an SiX phase, thereby being capable of decreasing the specific resistance of the supermicroparticle. Consequently, the supermicroparticle is easily alloyed with lithium upon charge-discharge cycling, and the charge-discharge capacity of the negative active material is increased.

In a preferred embodiment. the negative active material of the present invention also exhibits a Raman shift peak for Si in the supermicroparticle that is preferably in the range of 480 cm⁻¹ to 520 cm⁻¹, and a full width at half-maximum of the Raman shift peak that is preferably in the range of 5 cm⁻¹ to 70 cm⁻¹.

As it is believed that the supermicroparticles have Raman shift peaks within the range, and are particles consisting primarily of a non-crystalline or amorphous phase, even when alloyed with lithium, they have low volume expansion and excellent cycle characteristics.

Further, as it is believed that the supermicroparticles have the full width at half-maximum of Raman shift peak within the range, and are particles consisting primarily of a non-crystalline or amorphous phase, even when alloyed with lithium, they have low volume expansion and are able to improve the cycle characteristics.

It is preferable that at least one supermicroparticle is immobilized onto the surface of the graphite particle.

It is more preferable that the supermicroparticles are immobilized onto the surface of the graphite particle, and a thin carbon layer is formed on the surfaces of the graphite particle.

According to the composition, as the supermicroparticles having relatively high specific resistances are immobilized onto the surface of graphite particles having a relatively low specific resistance, the supply of electrons to the supermicroparticles are efficiently mediated via the graphite particles, so it is possible to lower the specific resistance of a negative active material itself.

Further, according to the composition, by forming a thin carbon layer on the surfaces of the graphite particles, the detachment of supermicroparticles from the surface of graphite powder is prevented which prevents the destruction of the negative active material so the cycle characteristics are improved.

Further, the present invention provides a rechargeable lithium battery including the negative active material described above. As the rechargeable lithium battery includes the negative active material described above, improved cycle characteristics are revealed.

Further, the present invention provides a method for preparing a negative active material for a rechargeable lithium battery. In this method, supermicroparticles made of elements alloyable with lithium and having a diameter in the range of 1 nm to 100 nm are produced using an evaporation method under a gas atmosphere, and the supermicroparticles are mechanically immobilized onto the surfaces of graphite particles.

The supermicroparticles produced using an evaporation method under a gas atmosphere have a diameter distribution range from 1 nm to 100 nm and contain particles having a maximum diameter of 100 nm. Such supermicroparticles, due to the size effect, have different crystalline structures compared to larger particles, even when alloyed with lithium, and experience less volume change. Accordingly, even with charge-discharge cycling following the aggregation of supermicroparticles and graphite particles, the detachment of the supermicroparticles from the graphite particles is prevented, improving the cycle characteristics. Thus, it is possible to obtain a negative active material with excellent cycle characteristics.

Further, after the immobilizing process, in one embodiment, a thin carbon layer is formed on the surfaces of the graphite particles.

According to this embodiment, the thin carbon layer further prevents separation of supermicroparticles from the surface of the graphite particles. Hence it is possible to obtain a negative active material with still further improved cycle characteristics.

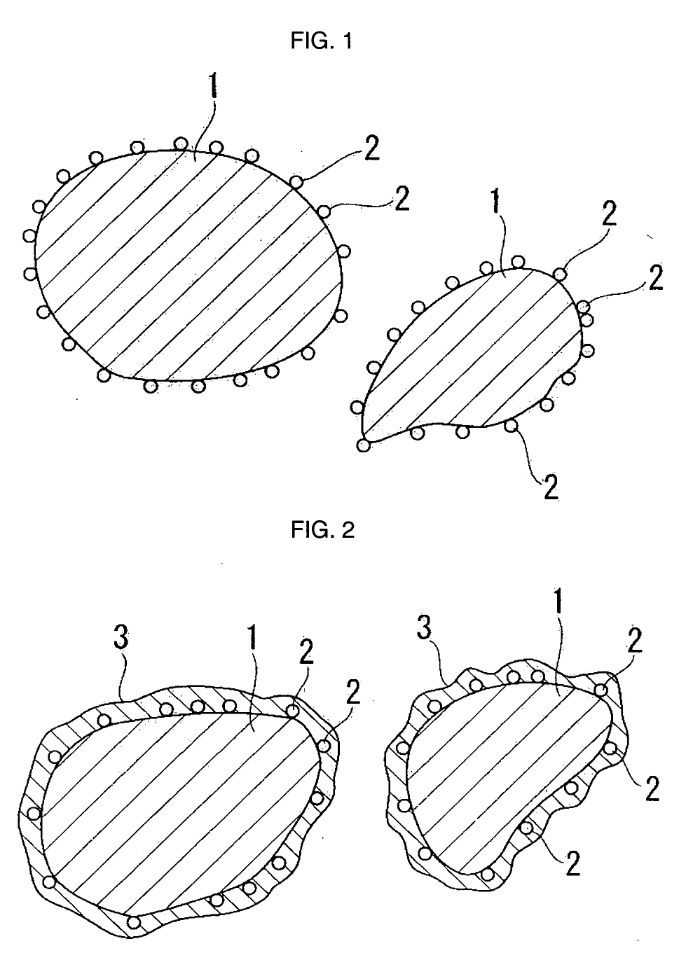

The embodiment of the present invention will now be described with reference to the accompanying drawings. FIG. 1 is a schematic drawing illustrating one embodiment of a negative active material for a rechargeable lithium battery. FIG. 2 is a schematic drawing illustrating another embodiment of a negative active material for a rechargeable lithium battery.

A negative active material for a rechargeable lithium battery is illustrated in FIG. 1 and consists of a composite of a graphite particle 1 and supermicroparticles 2. That is, as shown in FIG. 1, supermicroparticles 2 are immobilized onto the surface of the graphite particle 1.

The graphite particles 1 are made of natural graphite, artificial graphite, or the like, and have a diameter from about 3 μm to about 50 μm. As graphite particle 1 intercalates and deintercalates lithium upon the charge-discharge cycling, it functions as both a negative active material and a conductive agent. That is, as electrons move between supermicroparticles, an efficient charge-discharge reaction occurs on supermicroparticles 2.

Supermicroparticles 2 are made of elements alloyable with lithium and are produced using an evaporation method under a gas atmosphere. The diameter of the supermicroparticles is preferably between 1 nm and 100 nm and more preferably between 1 nm and 50 nm.

The negative active material is used in a negative electrode for a rechargeable lithium battery. Upon charging a rechargeable lithium battery, lithium transfers from a positive electrode and the negative electrode, wherein lithium is alloyed with supermicroparticles on the negative electrode and is injected to a graphite particle. The supermicroparticles alloyed with lithium experience little volume expansion, thereby improving the cycle characteristics of a rechargeable lithium battery.

It is thought that the reason for the low volume expansion, even when the supermicroparticles are alloyed with lithium, is attributed to the supermicroparticles having a diameter as small as between 1 nm and 100 nm and a narrow diameter distribution range compared to the powders that have a diameter of several μm's, and produced by conventional mechanical pulverization methods.

It is preferable that the supermicroparticles 2 are made of Si. As Si has a high charge-discharge capacity for lithium, it is possible to make a negative active material having a high capacity.

Further, supermicroparticles 2 preferably include both of Si and SiM phases and may contain either or both of X and SiX phases, where M is at least one element selected from the group consisting of Ni, Co, B, Cr, Cu, Fe, Mg, Mn, and Y, and X is at least one element selected from the group consisting of Ag, Cu, and Au, provided that M and X are not both Cu.

While the Si phase is alloyed with lithium upon charging to form a LiₓSi_{y} phase, it releases lithium upon discharging to return to the Si single phase.

Further, the SiM phase does not react with lithium upon charge-discharge cycling, maintaining the shape of the supermicroparticles 2 and preventing the volume expansion-contraction of supermicroparticles 2 themselves. Element M in the SiM phase is a metal element not alloyable with lithium and is at least one element selected from the group consisting of Ni, Co, B, Cr, Cu, Fe, Mn, Ti, and Y. In particular, the element M is preferably Ni, and in such an embodiment, the composition of the SiM phase is either Si₂Ni or SiNi.

Further, the X phase provides supermicroparticles 2 with conductivity, thereby lowering the specific resistance of the supermicroparticles 2 themselves. Element X including the X phase is an element having a specific resistance of 3Ωm or less, and is at least one element selected from the group consisting of Ag, Cu, and Au. In particular, Cu is not alloyable with lithium, thereby preventing volume expansion and thus being preferably used. Moreover, as Ag is nearly non-alloyable with Si, Ag exists as a single phase when a metal non-alloyable with Ag is selected as the element M, thereby improving particle conductivity and thus being a preferred choice.

That is, as Cu is alloyable with Si, and at the same time, has low resistance over Si, it has both properties of elements M and X. Therefore, according to the present invention, both elements M and X may be used, provided that Cu is not selected for both of elements M and X.

Further, either instead of or together with the X phase, the SiX phase may be deposited. The SiX phase lowers the specific resistance of a negative active material itself by providing supermicroparticles 2 with conductivity, as does the X phase.

The crystal structures of Si, SiM, X, and SiX phases are determined depending on the degree of evaporation, the composition of alloy, and the like. For the negative active material of the present embodiment, the whole part of each phase may be a crystalline phase, an amorphous phase, or a mixture of a crystalline phase and an amorphous phase. In addition to Si, SiM, X, and SiX phases, other alloy phases may be further included.

Accordingly, when it comes to the alloy composition, as Si is an element forming a Si single phase, a SiM phase, or a SiX phase, even when it is present in an alloy form to produce a SiM phase and a SiX phase, it is possible to obtain the Si capacity by properly selecting a composition ratio so as to produce an additional Si single phase. However, with an excess amount of Si, as the Si phase is excessively deposited, the amount of volume contraction of the total negative active material upon charge-discharge cycling increases, which in turn can pulverize the negative active material and deteriorate the cycle characteristics, which are not desirable. Specifically, the composition of Si in a negative active material is preferably in the range from 30% to 70% by mass.

As the element M is an element forming an SiM phase together with Si, it is preferable that the element M may be present in an alloy form and then added in such a way that its total amount should be completely alloyed with Si. When the amount of the element M exceeds the amount alloyable with Si, Si slips off prior to being alloyed, thereby decreasing capacity by a large margin, which is not desirable. In contrast, the lesser the amount of element M, the less the amount of an SiM phase, thereby decreasing the expansion prevention effect as well as deteriorating the cycle characteristics, which is also not desirable. Further, multiple phases other than the M phase may coexist so as to have M1, M2, and M3 phases. As the solid solution limit of the element M and Si varies depending on the element, the composition ratio of the element M may not be specifically determined, but it is preferable to select the composition ratio having the Si phase much higher in amount compared to the composition ratio where Si and M are alloyed up to the solid solution limit. Further, as the element M is not alloyable with lithium, the reversible capacity is not observed.

Further, as the high composition ratio of X decreases the specific resistance, the Si phase decreases, lowering the charge-discharge capacity. In contrast, the low composition ratio of X increases the specific resistance of a negative active material, lowering the charge-discharge efficiency. Hence, the composition of X in a negative active material is preferably in the range from 1% to 30% by mass.

The supermicroparticles 2 of the present invention may be manufactured using an evaporation method under a gas atmosphere. The evaporation method under a gas atmosphere refers to a method for obtaining microparticle fine powders in which a vacuum vessel is filled with an inert gas and then the required materials are added under an inert gas atmosphere, wherein the gas particles produced by evaporation or sublimation collide with the inert gas particles to be slowly cooled and aggregated with one another, thereby producing microparticle in fine powders which are recovered.

As the vapor is removed in the manufacturing process for a negative active material of the present embodiment, an inert gas is introduced into a vacuum vessel at the reduced pressure of from 1×10⁻³ Pa to 1×10⁻⁴ Pa and then, under an inert gas atmosphere and under the increased pressure from 1×10⁻⁴ Pa to 5×10⁵ Pa, silicon ingots, silicon powders, and SiMX alloys are arc-discharged and heated to evaporate silicon or SiMX alloys. The resulting vapor particles collide with the inert gas particles, and are slowly cooled and aggregated with one another, thereby producing supermicroparticles which are recovered prior to producing ultra-fine powders.

In addition to noble gases such as argon, helium, and the like, N₂ gas and the like which have low reactivity with Si and SiMX alloys may be selected as the inert gas introduced into the vacuum vessel.

Further, for heating Si and SiMX alloys, in addition to arc-discharge, heater heating, inductive heating, laser heating, resistance heating, electron gun heating, or the like may be used. Conventionally, with the evaporation method under a gas atmosphere, the heating temperature is set about 100° C. to 200° C. higher than the melting point of the material being heated. While a low temperature causes difficulty in evaporation, a high temperature results in too slow a cooling speed, thereby failing to produce an amorphous material. For Si, the temperature is preferably from 1555° C. to 1700° C.

Under an inert gas atmosphere, as the slow-cooling of the evaporated molecules results in aggregation thereof to produce supermicroparticles, the molecules are randomly aggregated to form a structure composed of an amorphous material. Accordingly, supermicroparticle powders having a diameter in the range of 1 nm to 100 nm and a Raman shift in the range of 480 cm⁻¹ to 520 cm⁻¹ are obtained.

Further, it is preferable that the negative active material for a rechargeable lithium battery of the present embodiment has a Raman shift peak in the range of 480 cm⁻¹ to 520 cm⁻¹. While the Raman shift of the crystalline Si may be higher than 520 cm⁻¹, that of the amorphous Si is less than 520 cm⁻¹ and broad in peak shape. Consequently, in the negative active material of the present embodiment, given that the Raman shift is in the range of 480 cm⁻¹ to 520 cm⁻¹, it mainly consists of a structure made of an amorphous material and even when alloyed with lithium has low volume expansion as well as excellent cycle characteristics.

Further, it is preferable that the half width of the Raman shift peak is in the range of 5 cm⁻¹ to 70 cm⁻¹. When the half width of the Raman shift peak is within the range, particles with an amorphous or non-crystalline phase are thought be the dominant particles, therefore, even when alloyed with lithium, they have low volume expansion and excellent cycle characteristics.

When it comes to the method for manufacturing a negative active material for the rechargeable lithium battery, supermicroparticles having a diameter from 1 nm to 100 nm and preferably from 1 nm to 50 nm are first manufactured using the evaporation method under the gas atmosphere as described. Subsequently using a hybridizer and the like, supermicroparticles are mechanically immobilized onto the surface of graphite particles. The immobilization process is preferably carried out under an inert gas atmosphere to prevent oxidation of the supermicroparticles.

FIG. 2 illustrates another example of a negative active material for a rechargeable lithium battery. FIG. 2 is a schematic drawing illustrating an example of a negative active material for a rechargeable lithium battery as an embodiment of the present invention.

In FIG. 2 multiple supermicroparticles 2 are immobilized onto the surface of a graphite particle 1 and then a thin carbon layer 3 is formed on the surface of the graphite particle 1.

The thin carbon layer 3 is produced using a firing procedure under an inert gas atmosphere by mixing oil pitch with the graphite particle pre-alloyed with supermicroparticles. The thin carbon layer 3, as shown in FIG. 2, is preferably produced so as to coat the graphite particle 1 and supermicroparticles 2 simultaneously. Accordingly, the supermicroparticles 2 are firmly immobilized onto the surface of the graphite particle 1.

The thickness of the thin carbon layer 3 is preferably between 1 nm and 100 nm. A thin carbon layer 3 having a thickness of less than 1 nm would not coat the supermicroparticles completely, whereas a thin carbon layer 3 having a thickness of more than 100 nm would result in difficulties in alloying, inserting, or releasing lithium to or from the graphite particle 1 and the supermicroparticles 2.

The negative active material for a rechargeable lithium battery of the present invention first involves the production of supermicroparticles having a diameter between 1 nm and 100 nm and preferably between 1 nm and 50 nm using an evaporation method under the gas atmosphere as described above. Subsequently using a hybridizer and the like, the supermicroparticles are mechanically immobilized onto the surface of the graphite particles, which is preferably carried out under an inert gas atmosphere to prevent oxidation of the supermicroparticles.

Subsequently, oil mesophase pitch is mixed with the graphite particles with the immobilized supermicroparticles, followed by using a spray drier or the like to coat the mesophase pitch onto the composite particles. The composite particles are then dried. The resulting particles are subsequently heated to below 1000° C. under an inert gas atmosphere to fire the oil mesophase pitch so as to form a thin carbon layer. However, when the supermicroparticles are a SiMX-based alloy, the firing temperature is preferably below 900° C. A firing temperature above 900° C. causes melting of supermicroparticles, which is not desired.

As described above, the negative active material for a rechargeable lithium battery of the present embodiment, which contains supermicroparticles having a diameter between 1 nm and 100 nm and a maximum diameter of 100 nm, has little absolute volume change even when alloyed with lithium. Consequently, even when supermicroparticles and graphite particles are aggregated and subjected to charge-discharge cycling, the supermicroparticles do not detach from the graphite particles, thereby improving the cycle characteristics.

Furthermore, where the negative active material is used for a rechargeable lithium battery according to one embodiment of the present invention, the multiple supermicroparticles 2 having a relatively high specific resistance are immobilized onto the surface of a graphite particle 1 having a relatively low specific resistance so that electrons are efficiently supplied via the graphite particles to the supermicroparticles, thereby decreasing the specific resistance of the negative active material itself. Accordingly, the charge-discharge capacity of a negative active material can be further improved.

Moreover, where a thin carbon layer 3 is formed on the surface of the graphite particle 1, the supermicroparticles do not detach from the surface of the graphite particle and thus the destruction of the negative active material is prevented, thereby improving the cycle characteristics.

Furthermore, as the thin carbon layer 3 inserts and releases lithium to and from itself, the thin carbon layer further improves the charge-discharge capacity.

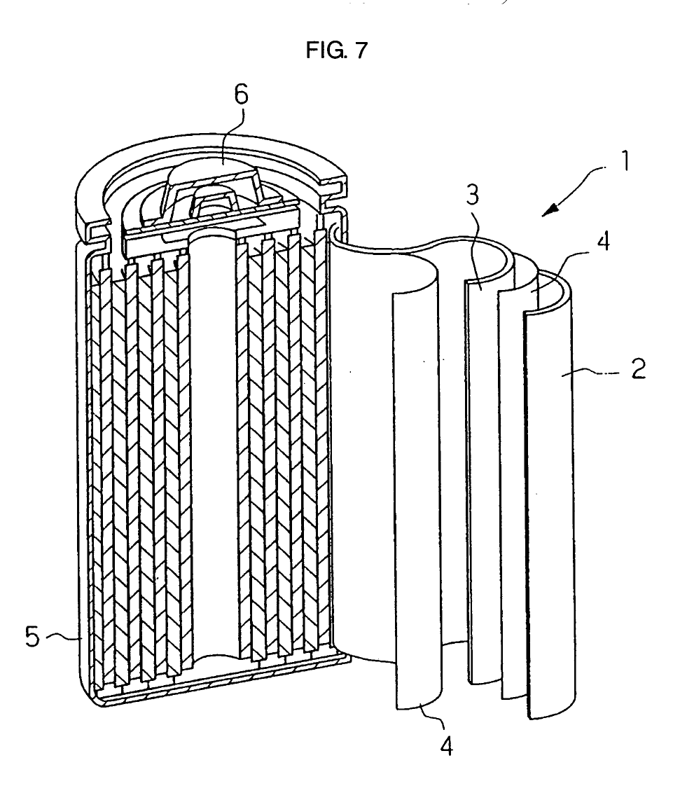

As shown in FIG. 7, the rechargeable lithium battery 1 of the present invention comprises an electrode assembly comprising a negative electrode 2 including the negative active material and a positive electrode 3 separated by a separator 4. The electrode assembly is immersed in an electrolyte within a battery case 5 and sealed with a sealing portion 6. However, the configuration of the rechargeable lithium battery is not limited to the structure shown in FIG. 7, as it can be readily modified into other types of batteries including prismatic batteries, pouch-type batteries and other types of batteries as are well understood in the related art.

The negative electrode includes, for example, those formed by mixing a negative active material, a binder such as polyvinylidene fluoride, and optionally a conductive agent such as carbon black, and shaping it into a sheet shape. However, it also includes a pellet solidified as a disk-like, plate-like, or cylinder-like shape.

Although a binder may be either an organic or an inorganic material, it should be dispersed or dissolved in a solvent together with a negative active material and, upon removal of the solvent, should link the negative active materials. Additionally, the binder may be a material that links negative active materials when mixed with a negative active material and subjected to solidification process such as a pressing process. Examples of such binders include, for example, vinyl-based resins, cellulose-based resins, phenol resins, thermoplastic resins, thermosetting resins, or the like, and specific examples include polyvinylidene fluoride, polyvinyl alcohol, carboxymethyl cellulose, styrene butadiene rubber, and the like.

The negative electrode of the present invention, in addition to a negative active material and a binder, may also contain carbon black as a conductive agent.

The positive electrode includes a positive active material capable of inserting and removing lithium, and examples include LiMn₂O₄, LiCoO₂, LiNiO₂, LiFeO₂, V₂O₅, TiS, MoS, organosulfide compounds, and organopolysulfide compounds.

Moreover, the positive electrode, in addition to the positive active material, may include a binder such as polyvinylidene fluoride or the like and a conductive agent such as carbon black or the like.

As a specific example of the positive electrode, the positive electrode may be coated onto a current collector made of a metal foil or a metal mesh and then pressed into a sheet-like shape.

The electrolyte includes a lithium salt dissolved in an aprotic solvent.

The aprotic solvent may include one or a mixture of two or more solvents selected from propylene carbonate, ethylene carbonate, butylene carbonate, benzonitrile, acetonitrile, tetrahydrofurane, 2-methyl tetrahydrofurane, γ-butyrolactone, dioxolane, 4-methyl dioxolane, N,N-dimethyl formamide, dimethyl acetoamide, dimethyl sulfoxide, dioxane, 1,2-dimethoxy ethane, sulfolane, dichloroethane, chlorobenzene, nitrobenzene, dimethyl carbonate, methylethyl carbonate, diethyl carbonate, methylpropyl carbonate, methylisopropyl carbonate, ethylbutyl carbonate, dipropyl carbonate, diisopropyl carbonate, dibutyl carbonate, diethylene glycol, dimethyl ether, and the like, preferably containing at least one of propylene carbonate (PC), ethylene carbonate (EC), and butylene carbonate (BC) as well as at least one of dimethyl carbonate, methylethyl carbonate (MEC), and diethyl carbonate (DEC).

In addition, the lithium salt may include at least one of LiPF₆, LiBF₄. LiSbF₆, LiAsF₆, LiClO₄, LiCF₃SO₃, Li(CF₃SO₂)₂N, LiC₄F₉SO₃, LiSbF₆, LiAlO₄, LiAlClO₄, LiN(CₓF₂ₓ₊,SO₂)(C_{y}F_{2y+1}SO₂)(where x and y are natural numbers), LiCl, LiI, and the like, and preferably contains at least one of LiPF₆ and LiBF₄.

The electrolyte may further be a polymeric electrolyte with a polymer such as PEO, PVA or similar polymers in combination with any one of the lithium salts.

Further, in addition to the positive electrode, the negative electrode, and the electrolyte, the rechargeable lithium battery may further include, if required, any other material such as a separator interposing the positive electrode and the negative electrode.

Hereinafter, the following examples and comparative examples illustrate the present invention in further detail. However, it is understood that the examples are for illustration only and that the present invention is not limited to these examples.

### EXAMPLE 1

The pressure inside a vacuum vessel containing silicon powder was set to 1.5×10⁵ Pa under a helium atmosphere and heated to 1700° C. using arc heating to generate silicon vapors. The resulting silicon vapors were cooled under a helium atmosphere. According to this process, the silicon vapors were aggregated and finally adhered as supermicroparticles onto the inner side of the vacuum vessel. This procedure was repeatedly carried out for 4 hours to produce powders made of Si supermicroparticles to be used for a negative active material.

### EXAMPLE 2

Si was prepared by the same procedure as in Example 1, the Si supermicroparticles were mixed with graphite powders having a diameter from 3 μm to 50 μm and, using a hybridizer under an argon gas atmosphere, and they were immobilized onto the surface of the graphite particles. The mixing ratio of the supermicroparticles and the graphite particles on a mass basis was 5:95. This procedure was used to produce composite particles.

Subsequently, after 10 parts by weight of oil mesophase pitch were mixed with 90 parts by weight of the composite particles, using a spray dryer, the oil mesophase pitch was coated onto the composite particles and dried, and then heated to 1000° C. under an argon atmosphere to fire the oil mesophase pitch so as to form carbonized films. According to this procedure, a negative active material was prepared.

### EXAMPLE 3

A negative active material was prepared by the same method as in Example 1, except that the supermicroparticles were produced from a mixed powder of Si, Ni, and Ag powders provided in a mass ratio of Si:Ni:Ag=55:35:10, instead of using the silicon powders.

### EXAMPLE 4

A negative active material was prepared by the same method as in Example 2, except that the supermicroparticles were produced from a mixed powder of Si, Ni, and Ag powders provided in a mass ratio of Si:Ni:Ag=55:35:10 and the firing temperature set to 900° C. after mixing oil mesophase pitch, instead of using the silicon powders and firing at 1000° C.

### COMPARATIVE EXAMPLE 1

A negative active material was prepared using the same method as in Example 1, except that instead of the supermicroparticles of the invention, silicon powder having particles with an average diameter of 1 μm (from High Purity Chemical Institute Ltd.) were pulverized using a bead mill to produce particles having an average diameter of 250 nm and a maximum diameter of 0.9 μm.

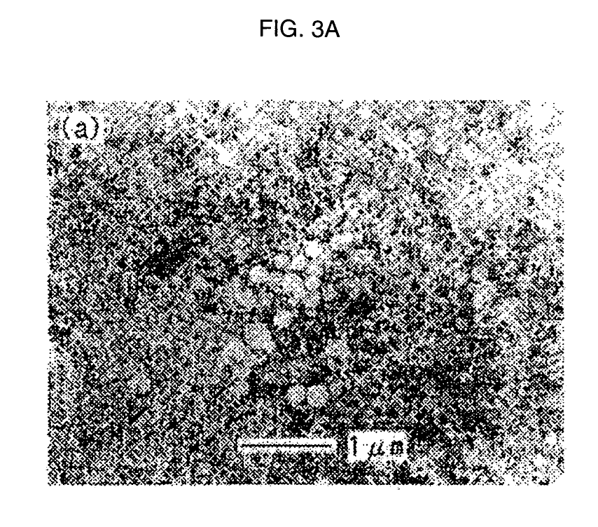

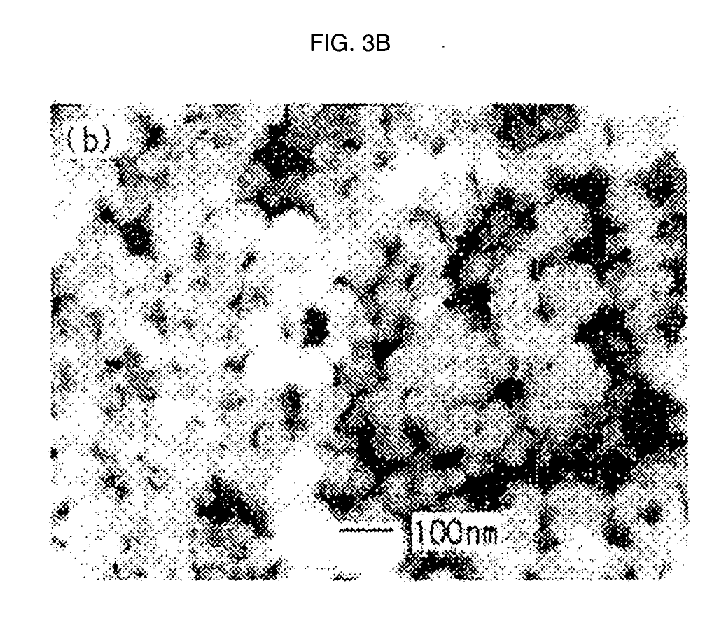

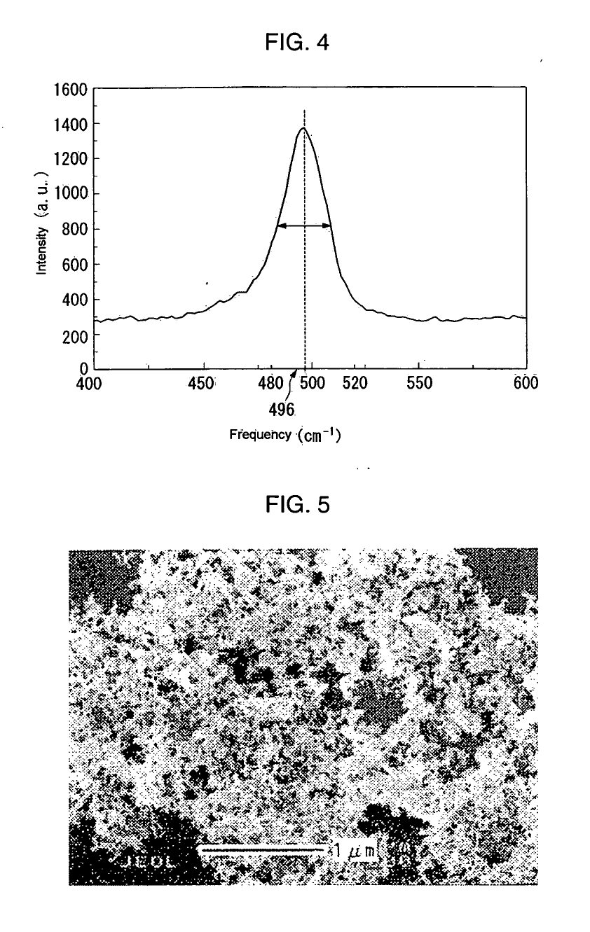

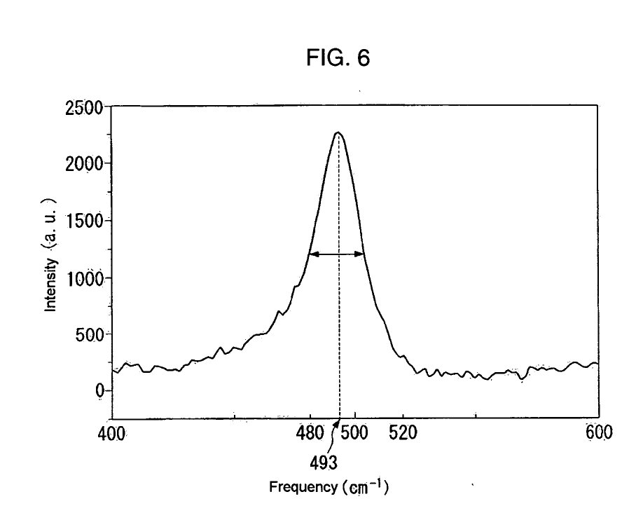

The supermicroparticles produced according to Examples 1 and 3 were examined under a scanning electron microscope to determine their shape. Additionally, their Raman spectra were collected using a Raman spectrometer. FIGS. 3A and 3B illustrate the SEM photos of the supermicroparticles of Example 1, and FIG. 4 illustrates the Raman spectrum of the supermicroparticles in Example 1. FIG. 5 illustrates the SEM photo of the supermicroparticles of Example 3, and FIG. 6 illustrates the Raman spectrum of the supermicroparticles in Example 3.

As illustrated in FIGS. 3A, 3B, and 5, none of the supermicroparticles in Examples 1 and 3 are more than 100 nm in diameter. In addition, as illustrated in FIG. 4 and FIG. 6, when their Raman spectra were determined, their peaks were at 496 cm⁻¹ and at 493 cm⁻¹ respectively and the half width of both peaks was 15 cm⁻¹.

Crystalline Si usually has a Raman peak near 520 cm⁻¹. Accordingly, all of the supermicroparticles in Examples 1 and 3 are thought to have non-crystalline structures, i.e., a collection of non-crystalline particles that are not amorphous.

Using the negative active material of Examples 1 through 4 and Comparative Example 1, coin-shaped lithium cells were fabricated.

Specifically, 70 parts by weight of each of the negative active materials of Examples 1 through 4 and Comparative Example 1 was individually mixed with 20 parts by weight of graphite powder having an average diameter of 2 μm as the conductive material, and 10 parts by weight of polyvinylidene fluoride in N-methyl pyrrolidone, and stirred to obtain a slurry. Subsequently, each slurry was coated onto a copper foil having a thickness of 14 μm and dried, followed by being compressed to produce a negative electrode having the thickness of 80 μm. Each of the negative electrodes was cut into a circle shape having a diameter of 13 mm, and the resulting negative electrodes and the lithium metal counter electrodes were wound and laminated together with a porous polypropylene separator. Then, an electrolyte that was prepared by adding 1 mole/I LiPF₆ to a mixed solvent of ethylene carbonate (EC), dimethoxyethane (DME), and diethylene carbonate (DEC) having a volume ratio of EC:DME:DEC=3:3:1 was injected to each to provide acoin-shaped lithium cells.

The lithium cells were charged and discharged 50 times at a battery voltage in the range of 0 V to 1.5 V and at a current density of 0.2 C.

With each of the cells of Examples 1 through 4 and Comparative Example 1, the discharge capacity at the first cycle, the charge-discharge efficiency (the ratio of the charge capacity to the discharge capacity) at the first cycle, and the capacity retention rate (discharge capacity at the fiftieth cycles to that at the first cycle) were individually measured. The results are shown in Table 1 below.

TABLE 1

| | Discharge | Charge-discharge | |
|---|---|---|---|
| | capacity at first | efficiency at first | Capacity |
| | cycle 1 (mAh/g) | cycle (%) | retention (%) |
| Example 1 | 462 | 92.5 | 90.5 |
| Example 2 | 455 | 91.1 | 92.8 |
| Example 3 | 442 | 92.7 | 94.9 |
| Example 4 | 437 | 91.3 | 96.4 |
| Comparative | 451 | 90.5 | 82.3 |
| Example 1 | | | |

As shown in Table 1, the discharge capacity at the first cycle in Examples 1 and 2 were not appreciably different from that in Comparative Example 1, whereas the capacity retention after 50 cycles was surprisingly better. The reason for this is thought to be that as the supermicroparticles are very small at 100 nm or less in diameter and their diameters are uniform, the volume change of the supermicroparticles is both small and consistently uniform upon charge-discharge cycling, thus preventing the destruction of the negative active material itself.

In addition, according to Example 2, the low initial charge and discharge capacity of the thin carbon layer causes a reduction in capacity of the negative electrode, but increases the strength of the negative active material, and prevents direct contact between the supermicroparticles and the electrolyte, thereby improving capacity retention after 50 cycles.

In Examples 3 and 4, as an SiNiAg alloy is used as the supermicroparticles, the Si content in the supermicroparticles is relatively low, thus lowering the discharge capacity by a small margin compared to those of Examples 1 and 2, even with the mass ratio of graphite to Si increased by 10 mass %.

However, the capacity retention after 50 cycles was improved compared to Examples 1 and 2. The reason for this is thought to be that the Ni in the alloy helps to prevent the expansion of the Si phase upon discharge, and with the addition of Ag, the conductivity rate of the supermicroparticles is improved to be similar to that of graphite. This allows the smooth insertion and the release of lithium ions during the charge-discharge cycling, and specifically, less lithium remains in the supermicroparticles at the later stage of the discharge.

In addition, in Example 4, the capacity retention after 50 cycles is thought to be much improved due to the same effect as in Example 2.

As described above, for the negative active material for a rechargeable lithium battery of the present invention, even with charge-discharge cycling following the aggregation of supermicroparticles and graphite particles, improved cycle characteristics are realized due to reduced detachment of the supermicroparticles from graphite particles.

While the present invention has been described in detail with reference to the preferred embodiments, those skilled in the art will appreciate that various modifications and substitutions can be made thereto without departing from the spirit and scope of the present invention as set forth in the appended claims.

1. A negative active material for a rechargeable lithium battery comprising:
a composite of a graphite particle and a plurality of supermicroparticles, wherein the supermicroparticles have diameters in the range of 1 nm to 100 nm, comprise elements alloyable with lithium, and are produced using an evaporation method under a gas atmosphere.

2. The negative active material for a rechargeable lithium battery according to claim 1, wherein the supermicroparticles have diameters in the range of 1 nm to 50 nm.

3. The negative active material for a rechargeable lithium battery according to claim 1, wherein the supermicroparticles comprise Si.

4. The negative active material for a rechargeable lithium battery according to claim 1, wherein the supermicroparticles include both Si and SiM phases and at least one of an Si phase and an SiX phase, where M is selected from the group consisting of Ni, Co, B, Cr, Cu, Fe, Mg, Mn, Y, and combinations thereof, and X is selected from the group consisting of Ag, Cu, Au, and combinations thereof, provided that M and X are not both Cu.

5. The negative active material for a rechargeable lithium battery according to claim 1, wherein a Raman shift peak for Si included in the supermicroparticles is in the range of 480 cm⁻¹ to 520 cm⁻¹.

6. The negative active material for a rechargeable lithium battery according to claim 5, wherein a full width at half-maximum of the Raman shift peak is in the range of 5 cm⁻¹ to 70 cm⁻¹.

7. The negative active material for a rechargeable lithium battery according to claim 1, wherein the supermicroparticles are immobilized onto the surface of a plurality of graphite particles.

8. The negative active material for a rechargeable lithium battery according to claim 7 further comprising a thin carbon layer formed on the surface of the graphite particles.

9. A rechargeable lithium battery comprising:
a negative electrode comprising a negative active material comprising a composite of a graphite particle and a plurality of supermicroparticles, wherein the supermicroparticles have a diameter in the range of 1 nm to 100 nm, comprise elements alloyable with lithium and are produced using an evaporation method under a gas atmosphere.;
a positive electrode; and
an electrolyte.

10. The rechargeable lithium battery according to claim 9, wherein the supermicroparticles have diameters in the range of 1 nm to 50 nm.

11. The rechargeable lithium battery according to claim 9, wherein the supermicroparticles comprise Si.

12. The rechargeable lithium battery according to claim 9, wherein the supermicroparticles include both Si and SiM phases and at least one of an Si phase and an SiX phase, where M is selected from the group consisting of Ni, Co, B, Cr, Cu, Fe, Mg, Mn, Y, and combinations thereof, and X is selected from the group consisting of Ag, Cu, Au, and combinations thereof, provided that M and X are not both Cu.

13. The rechargeable lithium battery according to claim 9, wherein a Raman shift peak for Si included in the supermicroparticles is in the range of 480 cm⁻¹ to 520 cm⁻¹.

14. The rechargeable lithium battery according to claim 13, wherein a full width at half-maximum of the Raman shift peak is in the range of 5 cm⁻¹ to 70 cm⁻¹.

15. The rechargeable lithium battery according to claim 9, wherein the supermicroparticles are immobilized onto the surface of a plurality of graphite particles.

16. The rechargeable lithium battery according to claim 15 further comprising a thin carbon layer formed on the surface of the graphite particles.

17. A method for preparing a negative active material for a rechargeable lithium battery, comprising:
producing a plurality of supermicroparticles made of elements alloyable with lithium having a diameter in the range of 1 nm to 100 nm using an evaporation method under a gas atmosphere and
immobilizing the supermicroparticles onto a surface of a graphite particle mechanically.

18. The method for preparing a negative active material for a rechargeable lithium battery according to claim 17, further comprises coating the supermicroparticles with a thin carbon layer after immobilizing.
